(19) United States
(12) Patent Application Publication
(10) Pub. No.: US 2008/0185192 A1
(43) Pub. Date: Aug. 7, 2008

(54) TOUCH PANEL

(76) Inventor: Lung-Sheng HSIH, Taipei (TW)

Correspondence Address: Rabin & Berdo, P.C., Suite 500, 1101 14th Street, Washington, DC, 20005, US

(21) Appl. No.: 11/671,497

(22) Filed: Feb. 6, 2007

(51) Int. Cl. G06F 3/033

(52) U.S. Cl. 178/18.05

(57) ABSTRACT

A touch panel has a substrate, a touching layer, an interval frame and a moisture resisting assembly. First and second electric conductive layers are formed respectively on opposite surfaces of the substrate and the touching layer. The interval frame is formed between the substrate and the touching layer to form a space and has an air hole. The moisture resisting assembly is mounted in the air hole to allow air entering the space and prevent moisture entering the space.

### BACKGROUND OF THE INVENTION

1. Field of the Invention

The present invention relates to a touch panel, and particularly to a touch panel with a moisture resister.

2. Description of the Related Art

The conventional touch panel has a substrate, a touching layer, an interval frame located between the substrate and the touching layer and two ITO (indium-tin oxide) conductive layers. The substrate is made of glass or PET (Polyethylene Terephthalate) and is rectangular. The touching layer is made of PET, and has a shape similar to the substrate. The ITO conductive layers are formed respectively on faces of the substrate and the touching layer.

When the user touches the touching layer, a small deformation is formed, and the touching layer will contact the substrate. Then the ITO conductive layers contact each other and electrically connect to each other to cause the voltage vectors to change. Therefore, the location the user touched is detected, and the conventional touch panel performs the according function.

However, the space between the substrate and the touching layer is airtight so air in the space will expand or contract with the temperature, and deform the touching layer.

Another conventional touch panel has multiple air holes defined in the interval frame to offset the temperature effect. However, the ambient moisture outside will enter the space between the touching layer and the substrate through the air holes and damage the touch panel.

Therefore, the invention provides a touch panel with a moisture resisting assembly to mitigate or obviate the aforementioned problems.

### SUMMARY OF THE INVENTION

The main objective of the present invention is to provide a touch panel comprising a substrate, a touching layer, an interval frame and a moisture resisting assembly. First and second electric conductive layers formed respectively on opposite surfaces of the substrate and the touching layer. The interval frame is formed between the substrate and the touching layer to form a space and has an air hole. The moisture resisting assembly is mounted in the air hole to allow air entering the space and prevent moisture entering the space.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective view of a touch panel in accordance with this invention;

FIG. 2 is a cross-sectional side view of the touch panel in FIG. 1;

FIG. 3 is an enlarged partial perspective view of the touch panel in FIG. 1 showing an air hole and a first embodiment of a moisture resisting assembly;

FIG. 4 is a side view of the moisture resisting assembly in FIG. 3;

FIG. 5 is an enlarged partial perspective view of the touch panel in FIG. 1 showing the air hole and a second embodiment of a moisture resisting assembly;

FIG. 6 is a side view of the moisture resisting assembly in FIG. 5; and

FIG. 7 is an enlarged partial perspective view of the touch panel in FIG. 1 showing the air hole and a third embodiment of a moisture resisting assembly.

### DETAILED DESCRIPTION OF THE PREFERRED EMBODIMENT

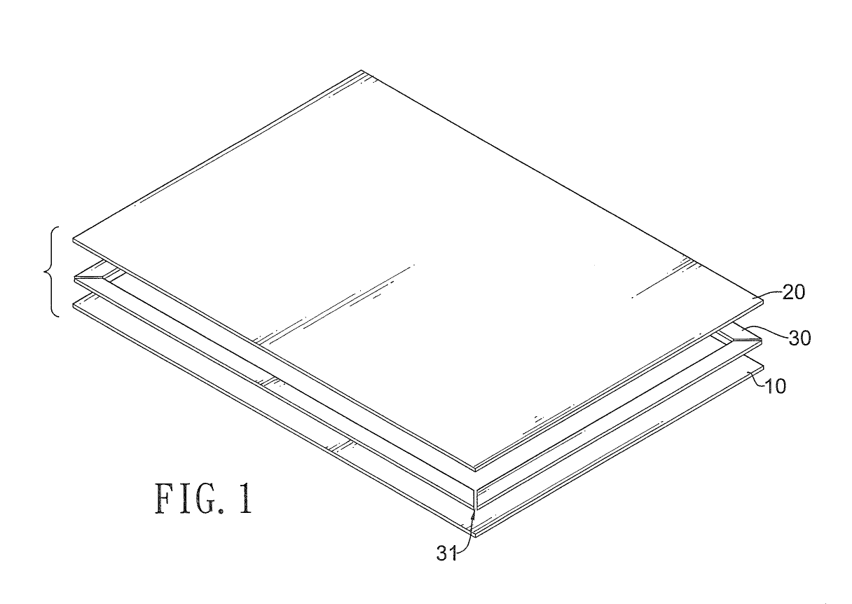

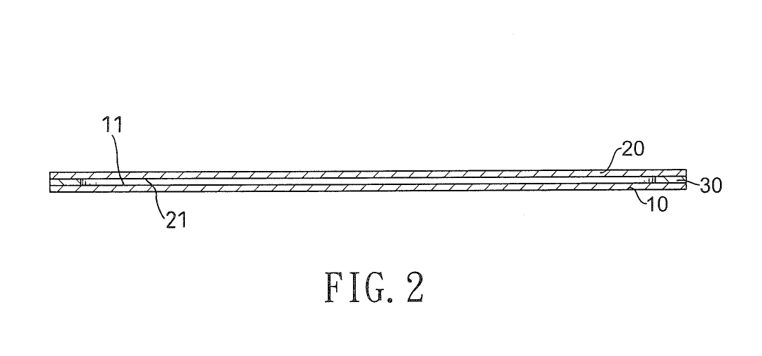

With reference to FIGS. 1, 2 and 3, a touch panel in accordance with the present invention has a substrate (10), a touching layer (20), an interval frame (30) and at least one moisture resisting assembly (40).

The substrate (10) is rectangular, is made of glass and has a top face and a first ITO (indium tin oxide) conductive layer (11). The first ITO conductive layer (11) is formed on the top surface of the substrate (10).

The touching layer (20) is rectangular, is made of PET (Polyethylene Terephthalate). The size and shape of the touching layer (20) corresponds to those of the substrate (10). The touching layer (20) has a bottom surface and a second ITO conductive layer (21). The bottom surface of the touching layer (20) faces the top surface of the substrate (10). The second ITO conductive layer (21) is formed on the bottom surface of the touching layer (20) and selectively contacts and selectively electrically connects to the first ITO conductive layer (11).

The interval frame (30) is mounted annularly between the substrate (10) and the touching layer (20) to form a space between the substrate (10) and the touching layer (20) and has a similar size with that of the substrate (10) and the touching layer (20). The interval frame (30) has four edges and at least one air hole (31). Each air hole (31) is formed through one of the four edges of the interval frame (30) to communicate the space with the outside environment and may be a cutout or a through hole.

With further reference to FIGS. 4 to 7, each moisture resisting assembly (40, 50, 60) is mounted in each air hole (31) and may comprise multiple moisture resisting sheets (41), multiple moisture filtering members (51) or multiple moisture resisting sheets (61) and multiple moisture filtering members (62).

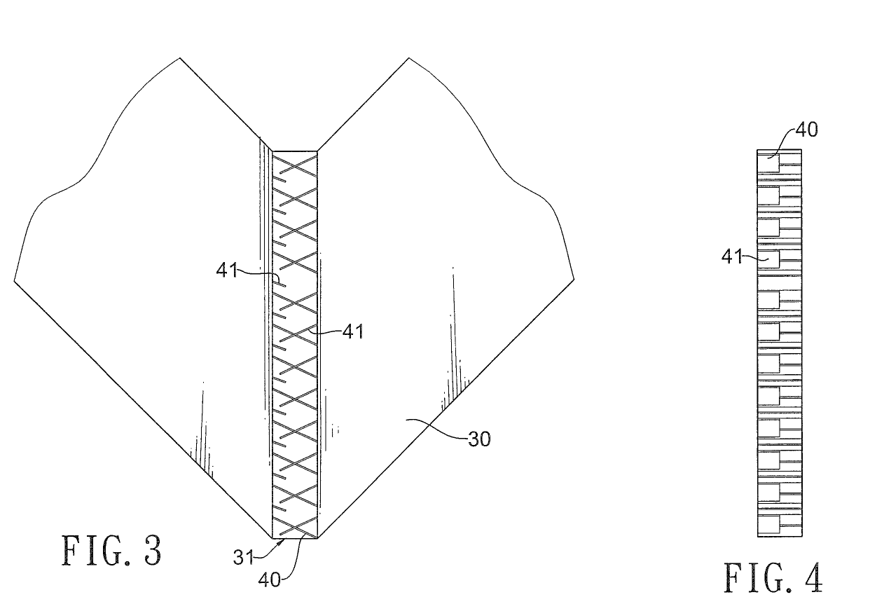

With reference to FIGS. 3 and 4, the moisture resisting sheets (41) are stagger arranged. The moisture resisting sheets (41) are insulating, are mounted inside of the air hole (31) and are crisscross to each other. Multiple spaces are formed between the moisture resisting sheets (41) and the inner wall of the air hole (31), so that air can pass through easily. When the air passes through the moisture resisting assembly (40), the moisture remains at the moisture resisting sheets (41), instead of entering to the cavity.

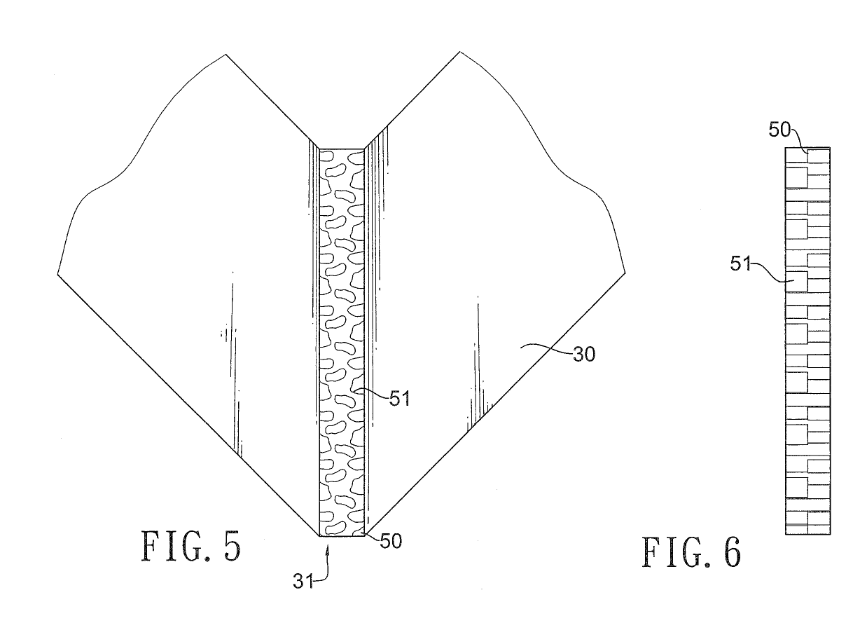

With reference to FIGS. 5 and 6, the moisture filtering members (51) block the moisture and filter the moisture. The shape of the moisture filtering members (51) is irregularity and is adhered to the inner wall of the air hole (31) by some binding agent. The adjacent moisture filtering members (51) are adhered to each other to prevent the moisture. Besides, the moisture filtering members (51) are sintered on the inner wall of the air hole (31), and the adjacent moisture filtering members (51) are also sintered to each other.

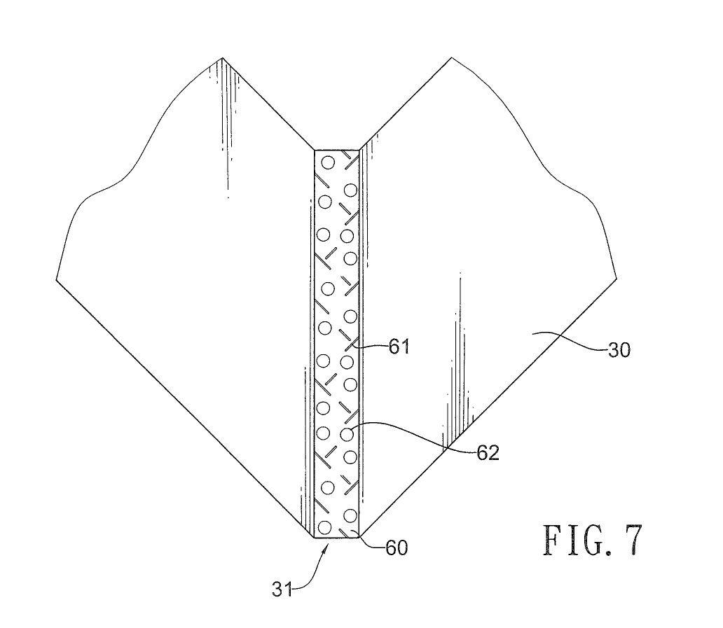

With reference to FIG. 7, the moisture resisting sheets (61) and the moisture filtering members (62) are mounted alternatively in the air hole (31). In this embodiment, the moisture filtering members (62) are circular, and located irregularly between the moisture resisting sheets (61) to prevent the moisture.

It is to be understood, however, that even though numerous characteristics and advantages of the present invention have been set forth in the foregoing description, together with details of the structure and function of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A touch panel comprising
a substrate having a top surface;
a touching layer having a bottom surface facing to the top surface of the substrate;
a first and second electric conductive layers formed respectively on the top surface of the substrate and the bottom surface of the touching layer;
an interval frame mounted annularly between the substrate and the touching layer to form a space between the substrate and the touching layer and having
four edges; and
at least one air hole, each one of the at least one air hole formed through one of the four edges of the interval frame; and
at least one moisture resisting assembly, each one of the at least one moisture resisting assembly mounted in a corresponding air hole of the interval frame to allow air entering the space and prevent moisture entering the space.

2. The touch panel as claimed in claim 1, wherein each one of the at least one moisture resisting assembly comprises multiple moisture resisting sheets mounted crisscross in the corresponding air hole of the interval frame.

3. The touch panel as claimed in claim 2, wherein the moisture resisting sheets extend into the corresponding air hole of the interval frame.

4. The touch panel as claimed in claim 2, wherein the moisture resisting sheets are insulating.

5. The touch panel as claimed in claim 1, wherein each one of the at least one moisture resisting assembly comprises multiple moisture filtering members.

6. The touch panel as claimed in claim 1, wherein each one of the at least one moisture resisting assembly comprises multiple moisture resisting sheets and multiple moisture filtering members mounted alternatively in the corresponding air hole of the interval frame.

7. The touching control panel claimed in claim 1, wherein each one of the at least one air hole of the interval frame is a cutout.

8. The touching control panel claimed in claim 1, wherein each one of the at least one air hole of the interval frame is a through hole.

9. The touch panel claimed in claim 1, wherein the substrate and the touching layer are rectangular and are similar to each other.

10. The touch panel claimed in claim 9, wherein the interval frame is a rectangular frame.
